(19) United States
(12) Patent Application Publication
(10) Pub. No.: US 2002/0186942 A1
(43) Pub. Date: Dec. 12, 2002

(54) Low-loss highly phosphorus-doped fibers for Raman amplification

(76) Inventors: Mikhail M. Bubnov, Moscow (RU); Evelyn M. DeLiso, Corning, NY (US); Evgeny M. Dianov, Moscow (RU); Alexey N. Guryanov, Nizhny Novgorod (RU); Vladimir F. Khopin, Nizhny Novgorod (RU); Dmitri V. Kuksenkov, Painted Post, NY (US); Michael T. Murtagh, Horseheads, NY (US); Ji Wang, Painted Post, NY (US)

Correspondence Address: CORNING INCORPORATED, SP-TI-3-1, CORNING, NY, 14831

(21) Appl. No.: 10/136,654

(22) Filed: Apr. 30, 2002

Related U.S. Application Data
(60) Provisional application No. 60/287,909, filed on May 1, 2001.

(51) Int. Cl. G02B 6/16; C03B 37/023

(52) U.S. Cl. 385/123; 65/413; 65/428; 65/435

(57) ABSTRACT

A method of making a phosphosilicate fiber comprises the steps of: (i) manufacturing a preform containing phosphorus doped silica; and (ii) drawing phosphosilicate fiber from said preform at a temperature in the range of 1700° C. to 1900° C.

### CROSS-REFERENCE TO RELATED APPLICATIONS

This application claims the benefit of U.S. Provisional Application Serial No. 60/287,909, filed May 1, 2001 entitled Low-Loss Highly Phosphorus-Doped Fibers For Raman Amplification, by M. M. Bubnov, E. M. Dianov, and A. N. Guryanov.

### BACKGROUND OF THE INVENTION

1. Field of Invention

This invention generally relates to the technology of optical fiber making and more particularly to the manufacture of phosphorus-doped optical fiber for Raman amplification.

2. Technical Background

Propagation of a high power pump laser beam through an optical fiber creates an optical gain based on stimulated Raman scattering. The optical gain is characterized by gain spectrum, with signal wavelengths that are longer than the optical pump wavelengths. The bandwidth and amplitude of this gain spectrum are dependent on the dopants present in the optical fiber. If the signal wavelength falls within the Raman gain spectrum, amplification of the signal is achieved via stimulated Raman scattering.

The Raman gain is related to the power transfer from the optical pump power to the optical power at signal wavelengths (Stokes wavelengths) and is expressed by:

Raman gain factor G(dB)=(10 log₁₀e)g₀PL_{eff}/A_{eff}, (1)

where P is the pump power, g₀ is the Raman gain or scattering coefficient and, A_{eff} is the effective core area of the optical fiber. The effective core area A_{eff} is defined as the area overlap integral between optical pump and optical signal power profiles, and L_{eff} is the effective fiber interaction length. The quantity L_{eff} is defined by:

L_{eff}=(1−exp(−αₚL))/αₚ, (2)

where αₚ is the fiber loss coefficient at the pump wavelength. Thus an optical fiber with a small effective area A_{eff} is preferred for efficient Raman amplification. Reducing the effective area A_{eff} of the optical fiber necessitates higher levels of doping in the core of the optical fiber. The higher is the core dopant level and therefore, the refractive index difference (or delta) between the core and the cladding of the optical fiber, the better optical signal power can be confined within a very small diameter core, reducing L_{eff} and thereby increasing Raman amplification efficiency. Phosphosilicate glasses are known for their large frequency shift due to Raman scattering. Phosphosilicate optical fibers have an intense and sharp Raman scattering peak at 1320 cm⁻¹, allowing signal band light centered at 1.5 μm to be directly generated via stimulated Raman scattering with a 1.3 μm pump light source. Thus the use of single mode, phosphosilicate fiber in cascaded Raman lasers can result in a simpler design and increase the efficiency of the Raman lasers. The Raman gain peak of the phosphosilicate optical fiber is relatively narrow, with the effective bandwidth of only about 6 nm at in the 1550 nm wavelength range. Pumping a phosphosilicate optical fiber with broadband or multiple-wavelength pump sources is advantageous because it allows one to adjust the relative pump power at various pump wavelengths. The resulting Raman gain can be made extremely uniform across the wide wavelength range.

Raman amplification in phosphosilicate fibers was first examined in the late 1980's. But, because of the large attenuation present in the phosphosilicate fiber, amplification was heretofore not efficient. Until recently, phosphosilicate fibers were rarely used in Raman amplifiers. Germanosilicate fibers were preferred because phosphosilicate glass has certain disadvantageous features in comparison with germanosilicate glass with the same doping level. The attenuation level attained up to now in such phosphosilicate-doped fibers with a low level of P₂O₅ doping (for example, 1-2 mol %) 0.2 dB/km; however, an increase of P₂O₅ concentration in the core up to 7-14 mol % produces a corresponding loss increase of 2-4 dB/km. In addition, the course of designing phosphosilicate fibers with high P₂O₅ concentration, the difficulties of working with the phosphosilicate glass manifest themselves distinctly. Due to the low molar refractivity of P₂O₅, higher doping level is needed to achieve the same core-cladding delta in comparison with germanosilicate glass. Yet, the high volatility of P₂O₅ together with the high diffusivity at temperatures typical of the preform fabrication process prevents achieving a high P₂O₅ doping level in preforms with a small core diameter (for example, 0.5-1.0 mm). At the same time, preforms with an increased core diameter (such as, for example, 2-3 mm) crack under thermal stress resulting from the mismatch of the thermal expansion coefficient of the P₂O₅doped core and the silica substrate tube. A low transition temperature of silica glass highly doped with P₂O₅ is also a cause of spontaneous fracture of the preform. It is possible to increase the fiber numerical aperture NA by adding GeO₂ or Al₂O₃ to the phosphosilicate core. Unfortunately, however, these co-dopants reduce the concentration of the phosphorus-oxygen double bonds in phosphosilicate glass responsible for Raman scattering.

### SUMMARY OF THE INVENTION

Single-mode, low optical loss fiber highly doped by P₂O₅, is advantageous preferable for the fabrication of efficient Raman lasers or amplifiers.

According to one aspect of the present invention a method of making a phosphosilicate fiber comprises the steps of: (i) manufacturing a preform containing phosphorus doped silica; and (ii) drawing phosphosilicate fiber from said preform at a temperature at or below 1900° C.

According to another aspect of the present invention an optical fiber comprises a silica core doped with 10 to 30 mole % of P₂O₅, the fiber having low scattering and absorption loss, so that optical signal traveling through said fiber is attenuated less than 2 dB/km. According to an embodiment of the present invention this phosphosilicate fiber has a small core diameter (less than 6 μm and preferable less than 4 μm) and attenuation losses of less than 1 dB/km. Thus, such fiber can be used advantageously in Raman applications that benefit from more efficient amplification with a lower pump power.

For a more complete understanding of the invention, its objects and advantages refer to the following specification and to the accompanying drawings. Additional features and advantages of the invention are set forth in the detailed description, which follows.

It should be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various features and embodiments of the invention, and together with the description serve to explain the principles and operation of the invention.

### BRIEF DESCRIPTION OF TABLES AND DRAWINGS

Table 1 lists spectral attenuation results (in dB/km) at various wavelengths for single-mode phosphosilicate fibers drawn from the same preform at different temperatures.

Table 2 presents optical losses (in dB/km) at wavelengths of 1.06, 1.24, 1.3, and 1.55 microns in single-mode, highly P₂O₅-doped fibers.

FIG. 1 is a graph of the spectral attenuation in dB/km versus wavelengths (as λ⁻⁴ in μm⁴) of single-mode phosphosilicate fibers drawn from the same preform at different temperatures.

FIG. 2 is a graph of the spectral attenuation in dB/km versus wavelength (in nm) of single-mode phosphosilicate fibers drawn from the same preform at different temperatures.

FIG. 3 is a schematic illustration of an MCVD preform collapsing process.

FIG. 4 shows the refractive index profile of an as-grown MCVD phosphosilicate preform.

FIG. 5 shows the refractive index profile of an intermediate MCVD phosphosilicate preform.

FIG. 6 shows the refractive index profile of a final MCVD phosphosilicate preform.

FIG. 7 is a schematic illustration of a Ballast plug.

FIG. 8 is a flow chart of an OVD process used to manufacture phosphosilicate fiber.

FIG. 9 is a flow chart of some of the steps of the process used to form a barrier layer.

FIG. 10 is a schematic illustration of the cross-section of the OVD-based phosphosilicate fiber, including the barrier layer.

FIG. 11 is a schematic illustration of a predicted refractive index profile for highly P₂O₅-doped fiber made via the OVD process.

FIG. 12 illustrates a measured refractive index profile for highly P₂O₅-doped cane made via the OVD process.

FIG. 13 is a graph of the spectral attenuation in dB/km versus wavelength⁻⁴ (as λ⁻⁴ in μm⁻⁴) of single-mode fibers with different P₂O₅ concentrations in the core.

FIG. 14 is a graph of the spectral attenuation in dB/km versus wavelength⁻⁴ (as λ⁴ in μm⁻⁴) of single-mode phosphosilicate fibers drawn from the same preform at different temperatures.

FIG. 15 is a schematic illustration of a perfectly square step-index profile with a 90 degree angle at the core-cladding interface and also an index profile with a 45° angle interface.

### DETAILED DESCRIPTION OF THE EMBODIMENTS OF THE PRESENT INVENTION

Reference will now be made in detail to the present preferred embodiment(s) of the invention, examples of which are illustrated in the accompanying drawings. Whenever possible, the same reference numerals will be used throughout the drawings to refer to the same or like parts. A method of making a phosphosilicate fiber, according to the present invention, includes steps of: (i) depositing glass material by chemical vapor deposition on a substrate; (ii) manufacturing a preform from this glass material; and (iii) drawing this preform into the phosphosilicate fiber at fiber drawn temperatures below 1900° C. It is preferable that this temperature be in the range of 1700° C. to 1900° C. The relatively low draw temperature allows lower attenuation (optical losses) than those associated with highly P₂O₅ doped fibers made by higher temperature draw processes. The lower attenuation is the result of reduction in stress in core-cladding interface and also reduction in defects and imperfections at the interfaces, which contribute to optical losses due to scattering.

The fiber preform is manufactured by the following steps: (i) laydown of initial core preform by vapor deposition of SiO₂ doped with P₂O₅ and 0 to 6 mole % of GeO₂ (preferably less than 2 mole % GeO₂); (ii) collapsing or consolidating the initial preform, thereby forming a phosphorus doped core diameter of >1.5 mm; and (iii) overcladding the initial preform with an additional amount of glass material to form a final preform. The laydown steps may include the use of fluorine gas to dope the core or cladding of the preform during the vapor deposition step. If fluorine is utilized, it is preferable that the core of the collapsed or consolidated initial preform contain 0.01-1.0 atomic wt %, of fluorine and more preferably 0.1 to 1.0 atomic wt % of fluorine, and most preferably about 0.25 atomic wt % of fluorine. The laydown step may be achieved by an inside or an outside vapor deposition. An inside vapor deposition step may utilize either a modified chemical vapor deposition (MCVD) or plasma chemical vapor deposition (PCVD) process. The deposition process may also be an outside vapor deposition (OVD) process. The overcladding step may include one or more glass sleeving steps or may be performed via OVD direct laydown process(s).

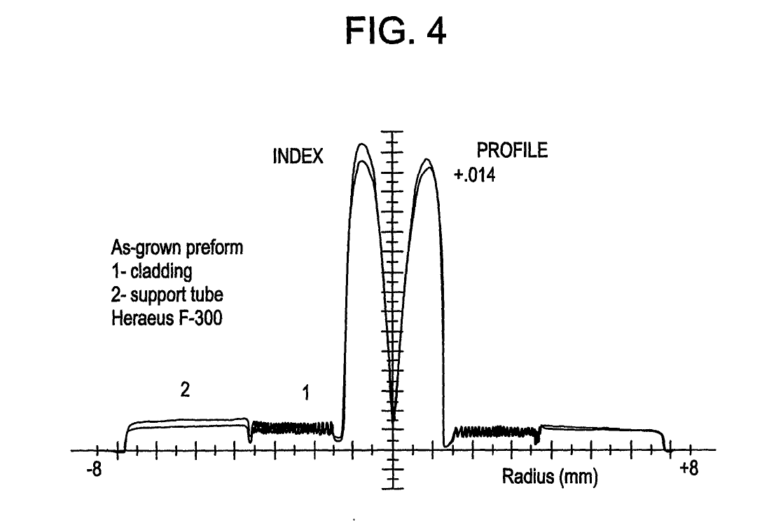

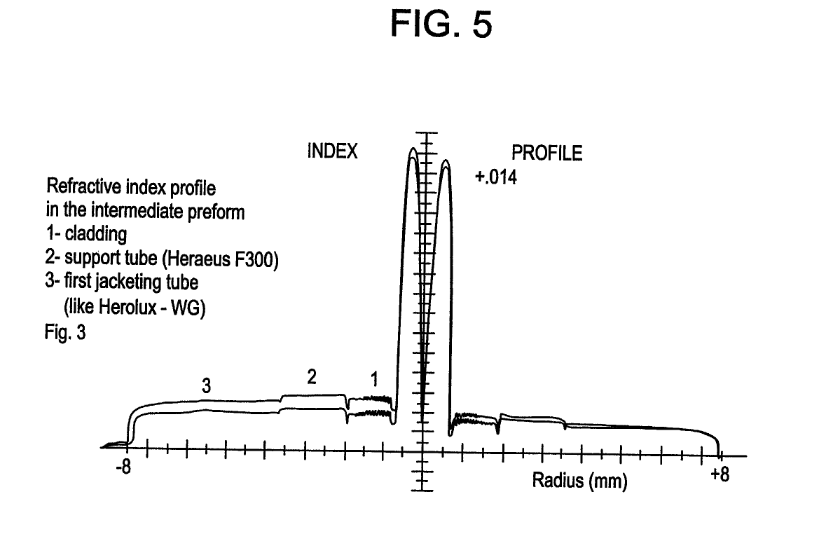

If the inside vapor deposition process is used, the collapsing step is required because the initial preform (formed by the inside vapor deposition process) is hollow and the inside of the core section of the initial preform needs to be collapsed on itself in order to eliminate the unneeded internal space. The collapsing step utilizes a burner that moves relative to the initial preform, along a preform's length. The burner heats a section of the initial preform, softening the inside portion of the preform and causing the preform to collapse, forming a solid core. Typical burner temperatures during the collapse step range between 2000° C.-2200° C. As shown in FIG. 3, as the burner is moving along the length of the initial preform, its flame provides a hot zone on the preform. The hot zone may be defined as the region of the preform which is ±6 inches from the center of the flame. The hot zone is an area of the preform that is kept above the softening point of the glass. It is preferable that the moving flame is positioned away from an open surface of the preform, so that the open surface of the preform is not in the hot zone. The open surface of the preform is that section of the core which has not yet been collapsed. It is also preferred that as the burner is moved along the length of said preform the burner is kept behind the collapsing front. (The collapsing front is the point in the preform at which collapse has most recently occurred. It is also preferable for the burner to move relatively slowly, i.e., at a speed of no more than 50 mm/minute, more preferably at a speed between 10 and 50 mm/minute, and most preferable at a speed between 10 and 40 mm/minute. If the inside vapor deposition process is utilized in manufacture of the initial preform, it is also preferable that the vapor deposition is done on inside wall of a substrate tube made of glass with a softening and melting temperatures lower than that of pure silica glass, typically less than 2000° C.-2200° C. Preferably this glass is a silica glass doped by any combination of F, B, P, and Ge. It is also preferable that the overcladding step is performed by sleeving the collapsed preform with sleeving tubes made of glass with a softening and melting temperatures lower than that of pure silica glass. It is preferred that the sleeving glass be silica glass doped by any combination of F, B, Ge and P.

Fibers with relatively large core doping level (for example, in the range of 10 to 30 mol. % P₂O₅) are preferred for Raman laser and amplifier applications. However, P₂O₅ has a relatively high diffusivity in silica at the temperatures characteristic for fiber processing. As a result, the initial doping level of P₂O₅ achieved in the laydown process (i.e., the process of depositing glassy material on a substrate by chemical vapor deposition CVD) is being reduced at each subsequent processing step due to the out-diffusion. This results in drop in a core glass refractive index delta. Therefore, it is preferable to deposit larger amounts of core material in comparison with the amounts used in standard single-mode fiber manufacturing. This can be illustrated by the example of an MCVD laydown process. Typically, the MCVD substrate tube has a wall thickness of 2.5 mm. Therefore, to achieve a core diameter of about 8 μm, approximately 0.4 mm thick layer of the core material has to be deposited on the substrate tube (substrate). If this is done, however, the core glass refractive index, due to P₂O₅ diffusion into the cladding glass would decrease very significantly at the stage of substrate tube collapse and fiber draw. This, in turn, results in smaller refractive index delta between the core and the cladding.

In order to reach refractive index delta Δn of 0.012-0.015 in the optical fiber it is preferable to have a core diameter of the initial preform of at least 1.5 mm. If the optical fiber is manufactured in a single step, then a substrate needed to get a fiber diameter close to or equal to 125 μm would have a wall thickness of about 25 mm, which can be impractical. Therefore, for high delta fibers, it is preferred to manufacture the fiber in at least two steps. At the first step, at least 1.5 mm of core glass material is deposited on the substrate tube, which is subsequently collapsed and drawn to the lower diameter. At the second step, an additional sleeving tube is collapsed or an additional cladding material is deposited by OVD process on the preform to bring the core/cladding diameter ratio to the value needed to produce single-mode fiber. A similar approach applies to fibers made entirely by OVD process.

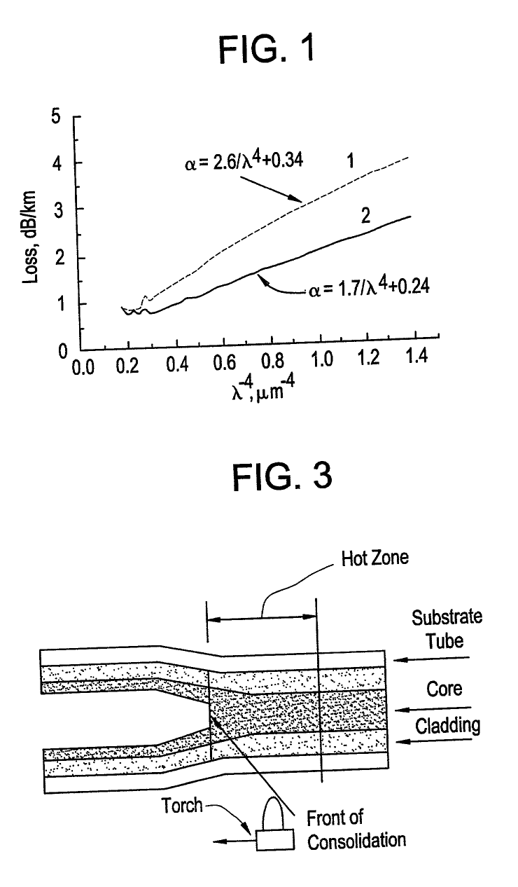

An additional doping of germanosilicate fiber core with fluorine is desirable to diminish Raleigh scattering and imperfection losses. This loss reduction occurs because fluorine reduces the viscosity of germanosilicate glass at temperatures typical of the MCVD process. As a result, germanium oxide diffuses more readily and the glass becomes more homogeneous. At temperatures typical of the MCVD or OVD processes, the viscosity of phosphosilicate glass is much lower than that of germanosilicate glass. In addition, the diffusion mobility of P₂O₅ is much higher than that of GeO₂. FIG. 1 illustrates optical loss (in dB/km) versus wavelength (as λ⁻⁴ in μm⁻⁴) for single-mode phosphosilicate fibers drawn from the same preform at different temperatures. In the illustrated example, the preform has 13 mol % P₂O₅,and 0.25 atomic % Curve 1 corresponds to a temperature of 1930° C.; Curve 2 corresponds to a temperature of 1820° C. The introduction of 0.01 to 1 atomic % of F, and more preferably from 0.01 to 0.25 atomic % F, into the highly-doped P₂O₅ core lowers optical losses. A further decrease of optical losses in this fiber is observed when the drawing temperature is lowered to 1820° C.

An illustrative embodiment of the invention also utilizes relatively soft substrate tubes. In fibers manufactured by MCVD or OVD, the greatest part of the fiber volume is formed by the silica glass that has the highest viscosity at the drawing temperature. It is possible to use a substrate/tube that is manufactured from a glass softer than silica. The softer substrate tubes allows one to: 1) decrease temperature and/or time needed to collapse a preform; and 2) further lower the draw temperature. Such substrate tubes may be, for example, Vycor™ glass tubes commercially available from Corning Incorporated, of Corning, N.Y.

Since for Raman applications the highest possible core to cladding index delta is desired, because this allows the effective core area to be decreased, it is also preferable to utilize silica glass doped with any combination of F, B, P, and Ge. It is more preferable to utilize silica doped with fluorine, or boron, or both, because these two dopants decrease the refractive index (of what is to become a cladding material). A highly desirable substrate tubing material appears to be silica doped with F and P₂O₅ in the largest amounts achievable by CVD, in such a proportion as to keep the refractive index of the doped material equal to that of the pure silica. Phosphorous doping is known to soften silica most effectively, and fluorine co-doping allows to preserve high core delta by “neutralizing” the cladding index increase caused by P₂O₅ doping. In addition to the advantages cited above, using a F-P₂O₅ codoped substrate tube allows to bring the cladding viscosity closer to that of the core and therefore decreases excess loss caused by the stress on core-cladding interface.

The use of a sleeving tube made of a glass softer than silica, such as phosphorus-doped silica, fluorine-doped silica, boron-doped silica, germania-doped silica, or a combination of the aforementioned materials like F—P₂O₅—SiO₂, may be utilized with MCVD, PCVD, or OVD-fabricated preforms. Sleeving is employed because of the large amount of material deposited in the core, in order to achieve a diameter close to or equal to the standard 125 micron diameter of single-mode fiber. Lower melting point materials such as boron, germania, phosphorus or fluorine in appropriate combinations and amounts may be used to fabricate the sleeving tube in order to best match the thermal expansion coefficient and viscosity of the core and inner cladding segments. The matching of the core, inner cladding (or sleeve), and outer cladding (or sleeve) in terms of the thermal expansion coefficient and viscosity is desired in order to minimize stresses in the glass and ultimately the fiber. High stresses can lead to defects, seeds, voids, and other problems in the fiber which can cause increased scattering loss and ultimately higher fiber attenuation. In addition, the softer sleeving tube allows for a lower temperature draw, which reduces fiber losses substantially as discussed above.

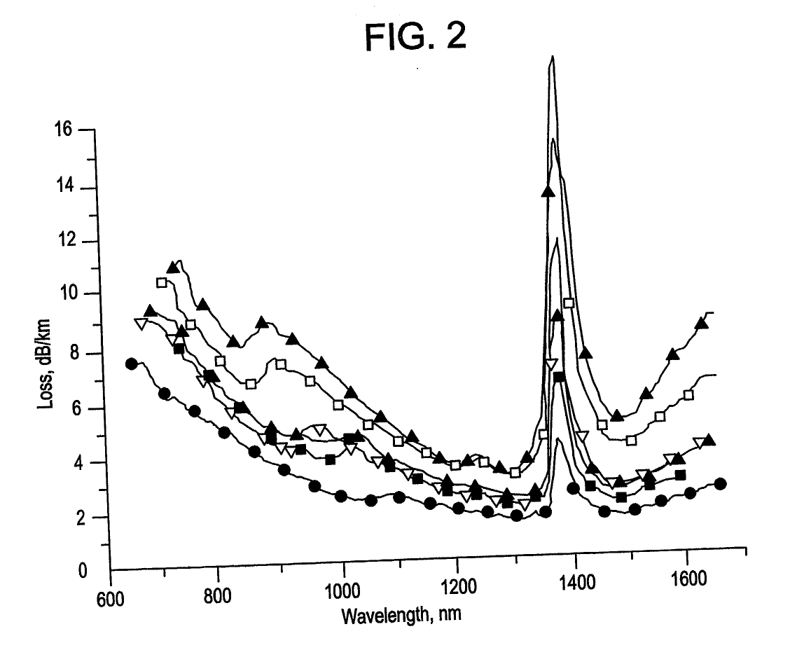

Low-melting temperature Vycor™ sleeving tubes are desirable in order to reduce the draw temperatures of phosphosilicate fibers by more than 100° C. Loss measurement results for P₂O₅-doped fibers drawn at temperatures ranging between 1820° C. and 1930° C. from the same preform are shown in FIG. 2. More specifically, FIG. 2 illustrates optical attenuation spectrum (in dB/km) versus wavelength (nm) of single mode phosphosilicate fibers drawn from the same preform at different temperatures. As can be seen from this figure, a substantial decrease in optical loss is observed as draw temperature is lowered.

It is also noted that instead of sleeving one can also utilize overcladding with the same material (for example, F—P₂O₅—SiO₂) by OVD and then consolidating the resulting preform.

Example of MCVD Process

More specifically, fluorine doped silica tubes from Heraeus Inc. under catalogue designations BRD or F-320) are utilized as the substrate tubes, the outer diameter D of the tubes being 20 mm and the wall thickness d₁ being 2 mm. The first deposited layer on the substrate tube is silica. The second layer is the compensated glass. In the present embodiment, the composition of the compensated deposited glass on the inside of the substrate tube is F—P₂O₅—SiO₂ and its refractive index is about 1×10⁻³ below that of pure silica glass. This glass is referred to as the compensated glass because it contains an index lowering dopant (for example, F) which compensates for the increased index of refraction caused by another dopant (for example, P₂O₅). Thus, although the compensated glass is softer than silica, its index of refraction is very close to that of pure silica. For the fabrication of a single-mode preform with the required cutoff wavelength λc (950 nm<λc<1500 nm and, preferably, 1000 nm<λc<1200 nm), during the collapsing and sleeving steps of the MCVD process the initial preform is sleeved with 2 to 3 sleeving tubes of the same diameter. Sleeving tubes of different compositions are utilized including those of phosphorus-doped silica, boron-doped silica, fluorine-doped silica, germania-doped silica, or a combination of the aforementioned materials.

Reaction of dopant precursors such as silicon tetrachloride and phosphorus tetrachloride with oxygen in the MCVD process proceeds completely at a temperature over 1100° C. The deposited ‘soot’ layer, including P₂O₅, is then sintered by raising into a transparent homogeneous glass by raising temperature. (The term “soot” refers to low density, porous, glassy material that has the same chemical composition as the resultant glass.) The higher the P₂O₅ concentration the less heating is required. Because P₂O₅ exhibits significant vaporization and diffusivity at temperatures characteristic of the MCVD process, especially at the stage of preform collapse these processing conditions needed to be optimized.

At deposition temperatures below 1400° C. significant variations of the preform core refractive index, both in radial and in axial directions, were observed. These optical inhomogeneities, which are due to P₂O₅ phase separation, lead to a considerable increase in measured optical fiber loss. At deposition temperatures over 1400° C. the optical inhomogeneities decreased significantly, due to the high diffusivity of P₂O₅, and optical losses in fibers decreased.

The collapsing step is an important part of manufacturing preforms with a high P₂O₅ content. X-ray microanalysis of the composition of phosphosilicate glass deposited on the substrate tube showed that the P₂O₅ concentration of the deposited glass deposited onto the substrate tube is approximately 30% higher than after the collapsing step. The preform temperature at the collapsing stage is determined by the softening point of silica, and it cannot be diminished considerably, but the duration of exposure of the deposited phosphosilicate glass surface to a high temperature can be significantly shortened. That is, it is important to minimize the amount of time the high temperature is applied to the substrate tube with the deposited soot.

Preform collapsing is performed by three burner passes and the heating-up of phosphosilicate glass reaches maximum temperature at the final stage of consolidation of the tubular preform into a solid rod. It may be assumed that P₂O₅ evaporates mainly at this stage of preform collapsing. According to this embodiment, an example of a preform collapsing procedure is described below:

Preform collapsing was performed by three burner passes. In the first pass, traversing torch speed was 40-45 mm/min. Hydrogen flow through the burner was 76 slpm (standard liters per minute). Oxygen flow through the burner was 38 slpm. In addition, 800 sccm of oxygen and 40-50 sccm of chlorine containing substances were flowed through the deposited tube preform in this stage. The pressure difference between the inside and outside the preform was 3 to 5 mm of water. The result was an inner diameter of the deposited preform which decreased to 9 to 10 mm.

In the second pass, traversing torch speed was 21 to 22 mm/min. Hydrogen flow through the burner was about 55 slpm. Oxygen flow through the burner was about 27 slpm. In addition, 800 sccm of oxygen and 6 to 8 sccm of Freon-113 (Fe compound) were flowed through the deposited tube preform in this stage. The pressure difference between the inside and outside the preform was about 3 to 5 mm of water. The result was that inner diameter of the deposited preform decreased to about 3 to 3.5 mm with simultaneous etching of layer with burnoff of P₂O₅.

In the third pass, before the capillary consolidation, traversing torch speed was about 11 mm/min. Hydrogen flow threw the burner was about 65 slpm. Oxygen flow through the burner was about 33 slm. The pressure difference between the inside and outside the preform was about 3 to 5 mm of water. After capillary consolidation traversing torch speed is about 11-13 mm/min. Hydrogen flow threw the burner is about 35 slpm. Oxygen flow through the burner is about 17 slpm. Pressure difference was the same.

The burner temperature ranged between about 1900° C.-2200° C. during the collapsing passes. An exemplary content of P₂O₅ and fluorine in cladding is 1 mol % and is 0.25% respectively.

We found that when the front of the preform consolidation (collapsing front) is located near the rear edge of the hot zone, the open surface of the deposited phosphosilicate glass is to be in the zone of maximum temperature with the result that the intensive vaporization of P₂O₅ takes place there. Having changed the burner traveling speed we moved the collapsing front to the fore part of the hot zone. This is illustrated in FIG. 3. As a result, an open surface of the deposited phosphosilicate glass fell outside the hot zone, and the P₂O₅ concentration in the core increased approximately by 20%.

At temperatures typical of the MCVD process, phosphorus pentoxide possesses higher volatility as well as higher diffusivity in comparison with germanium dioxide. Therefore, in the course of preform fabrication, especially at the stage of collapsing, the P₂O₅ concentration decreases not only in the surface layer, but, due to diffusion, also across the whole width of the deposited layer. However, applicants discovered that considerable magnification of the refractive index of phosphosilicate glass relative to the silica glass (Δn>1×10²) is attainable in a sufficiently thick deposited layer (10 to 100 deposited layers).

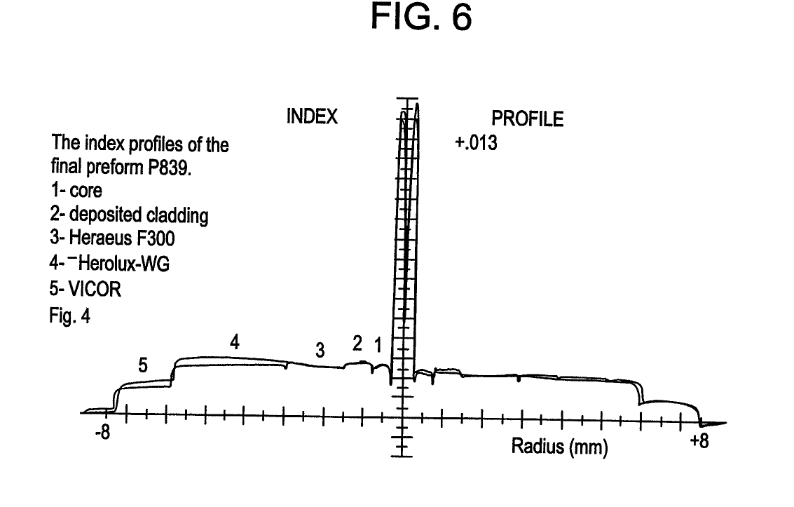

Following collapse, the preforms are sleeved and then drawn into fibers. Refractive index profiles of the as-grown, intermediate, and final preforms are shown in FIGS. 4-6, respectively.

Exemplary OVD Process

Low-loss, highly phosphorous-doped preforms of similar compositions to that mentioned above for MCVD can also be fabricated by the OVD process. The OVD process comprises a deposition step or steps in which a soot preform is formed from ultra-pure vapors caused to react in a flame to form fine soot particles of silica, phosphorus, and germania, and/or other dopants. The soot particles are deposited on the surface of a rotating target bait-rod. The core material is deposited first, followed by the pure silica cladding. As both core and cladding raw materials are vapor-deposited, the entire preform becomes totally synthetic and extremely pure.

When deposition is complete, the target rod is removed from the center of the preform to leave a centerline hole in the preform, and the preform is placed into a consolidation furnace. During the consolidation process, the water vapor is removed first from the preform by use of drying agent such as Cl₂, SiCl₄, GeCl₄, or POCl₃. The fiber preform may be removed of water vapor by the use of drying agents such as Cl₂, SiCl₄, GeCl₄, or POCl₃, at temperatures ranging from 700° C.-1100° C., preferably from 800-1000° C., and more preferably from 800-900° C.

Next, the preform is consolidated into a solid, dense, and transparent glass. Consolidation process may finish with the centerline hole open, which is eventually closed in the following redraw step at furnace temperatures ranging from 1600° C.-2100° C.

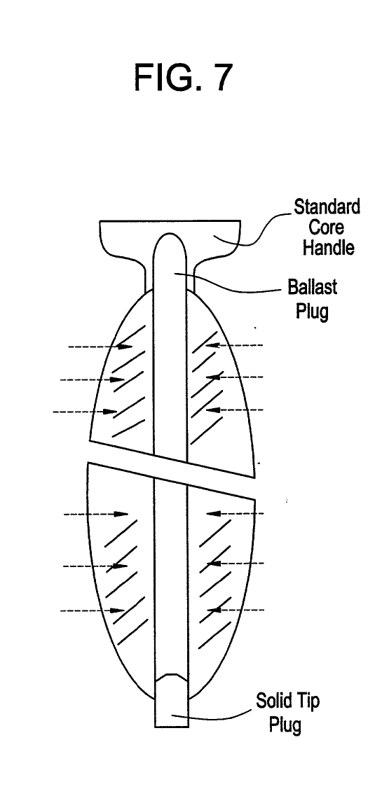

Alternatively, a Ballast plug, such as that shown in FIG. 7, may be inserted into the centerline of the soot preform prior to consolidation in order to reduce centerline rewetting of the preform following consolidation. A Ballast plug is a glass plug which is inserted into the centerline of the soot preform prior to consolidation in order to maintain the dryness of the centerline and to avoid centerline re-wetting. The Ballast plug is inserted in conjunction with a hollow tip plug prior to consolidation. The Ballast and tip plugs may be deuterium-treated, a process in which deuterium exchanges for hydrogen in the glass at necessary reaction temperatures, in order to reduce the contribution of centerline water in the preform from the glass plugs. Upon consolidation of the soot preform, the tip plug closes and the Ballast plug bonds to the sintered glass preform, thus sealing the centerline from any environmental exposure. The Ballast plug contains an etched, thin-walled segment, which allows for any trapped centerline gases, such as helium, to be diffused out of the blank at temperatures that equal to or are higher than 400° C. Once all gases have been removed from the centerline, an internal vacuum is formed, allowing the centerline hole to close during redraw without the use of an external vacuum source. The reduced internal vacuum and sealed centerline enable better centerline hole closure and a substantially drier (lower OH) glass.

Another alternative process involves the use of a consolidation procedure in which the centerline hole of the blank is substantially closed, enabling the minimization or overall elimination of seeds. Conventional manufacturing procedures, and the collapsing step in particular cause separation between the materials used for the core and cladding (due primarily to the materials' thermo-mechanical property mismatch) during formation of the phosphosilicate fibers. The separation can result in captured gas babbles in the cane, known as “seeds,” which in turn results in unacceptable fiber performance. According to one embodiment of the invention the consolidation process comprises sintering process, i.e. lower temperature consolidation with a slow down drive, in which the centerline hole is closed, after the initial drying process. The sintering process can be accomplished at 1250-1450° C., and more preferably, 1310+/−25° C., for a time period long enough to sinter the cladding layer and close the centerline hole. The fiber preform may be removed of water vapor by the use of drying agents such as Cl₂, SiCl₄, GeCl₄, or POCl₃, at temperatures ranging from 700° C.-1100° C., preferably from 800-1000° C., and more preferably from 800-900° C.

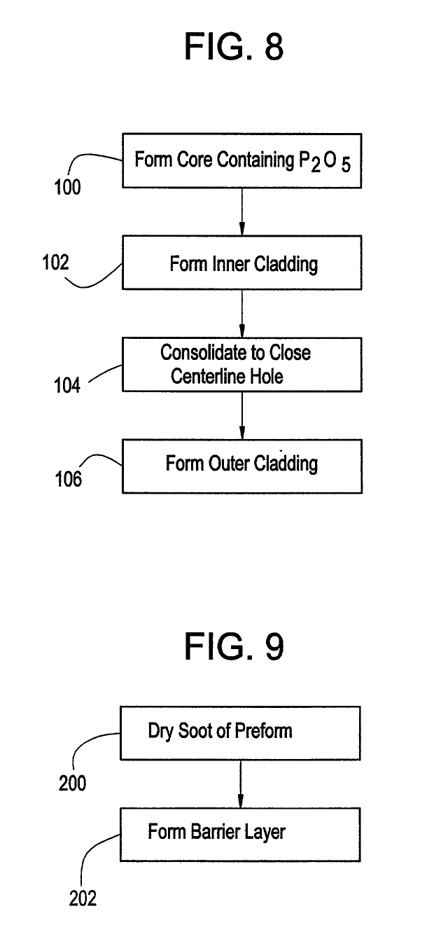

FIG. 8 illustrates an exemplary OVD method of manufacturing an optical fiber in accordance with a preferred embodiment of the invention. In step 100, a core glass composition having between 10 to 30% mol % P₂O₅ is formed, using an OVD process. For example, one or more laydown steps are performed utilizing ultrapure POCl₃ vapors reacting in a (CH₄+O₂) flame, to form soot particles on a rotating rod while the flame is scanned in the length direction of the rod.

In step 102, an inner cladding composition is formed on the outer surface of the core composition. The inner cladding composition may include silica doped by any combination of fluorine, boron, germania, and phosphorus and can be formed through any known process, such as an OVD process using one or more laydown steps. Other materials may also be utilized in forming the inner cladding. The inner cladding serves to minimize thermal and mechanical stresses between the core composition, and the outer cladding formed in the manner set forth below, as further processing is accomplished. Preferably the inner cladding substantially optically matches the outer cladding. That is, it has an index of refraction that is about the same as that of the outer cladding.

In step 104, the core composition and the inner cladding composition are consolidated by heating after removal of the rod. The sintering process-can be accomplished at 1250-1450° C., and more preferably, 1310+/−25° C. for a time period long enough to sinter the cladding layer and close the centerline. Drying may be done by the use of drying agents such as Cl₂, SiCl₄, GeCl₄, or POCl₃, at temperatures ranging from 700C-1100° C., preferably from 800-1000° C., and more preferably from 800-900° C.

Step 104 may include a doping process, such as doping during OVD consolidation, in which the inner cladding is doped with boron, fluorine, or another desirable material depending on the ultimate application of the optical fiber. For example, in erbium-doped L-band amplifiers and fiber lasers, it is known to dope the cladding with a lower melting point material, such as boron or fluorine, to decrease the thermal mismatch between the core and the cladding.

In step 106, an outer cladding composition is formed on the preform to define a cane which is suitable for further processing in a known manner to manufacture an optical fiber. The outer cladding can be formed with a standard OVD silica overclad process. A second option is to form the overclad by an OVD laydown process using materials such as silica, boron, germania, or fluorine in appropriate combinations and amounts in order to best match the thermal expansion coefficient and viscosity of the core and inner cladding segments. The matching of the core, inner cladding, and outer cladding in terms of the thermal expansion coefficient CTE and viscosity is desired in order to minimize stresses in the glass and ultimately the fiber. High stresses can lead to defects, seeds, voids, and other problems in the fiber which can cause increased scattering loss and ultimately higher fiber attenuation. Thus, it is preferred that the core, inner cladding and outer cladding have about the same CTE and viscosity. Alternatively, the outer cladding can be formed by inserting the preform into a sleeve, as described in a future following section. The cane can then be used to form an optical fiber through any known process, such as the drawing process described in a following section.

Significant migration of the doping composition into the core has been observed during consolidation. This dopant migration causes interactions between the core composition and the doping composition. Interaction of phosphorous and fluorine cause the formation of highly volatile complexes which lead to the escape of much of the phosphorous and fluorine from the preform. Thus it is important to prevent or minimize migration of the dopant into the core composition. Applicants have found that formation of a glassy barrier layer, preferably a layer that is highly dense and has a low water content, provides an effective barrier to prevent migration of the dopant.

The glassy barrier layer can be formed between the core composition and the inner cladding in any manner, such as with a vapor deposition process. Applicant has developed a process for forming such a layer that is very thin and highly effective as a barrier. FIG. 9 illustrates a process for forming the barrier layer of the preferred embodiment. The process of FIG. 9 can be accomplished after step 100 and prior to step 102 of FIG. 8 discussed above.

As illustrated in FIG. 9, after forming of the core composition but prior to forming of the inner cladding composition, the soot is dried in step 200. The drying step can be accomplished by application of a chlorine rich flame or other dry or non-OH flame sources. For example, carbon monoxide or deuterium can be used as flame sources. In step 202, a thin outer portion of the core composition is selectively consolidated to form a glassy barrier layer. Step 202 can be accomplished by applying heat with any laser or plasma source. For example, a microwave coupled plasma torch operating at about 3 kW can be used. It is preferable that the thermal radiation is absorbed primarily in the first several tens of microns of the core composition to provide good thickness control of the barrier layer. Preferably, the barrier layer is from 50 μm to 100 μm thick. Also, it has been found that use of a CO₂ laser for forming the barrier layer is desirable. Such a laser does not introduce water into the core composition and provides highly localized heating for accurate thickness control.

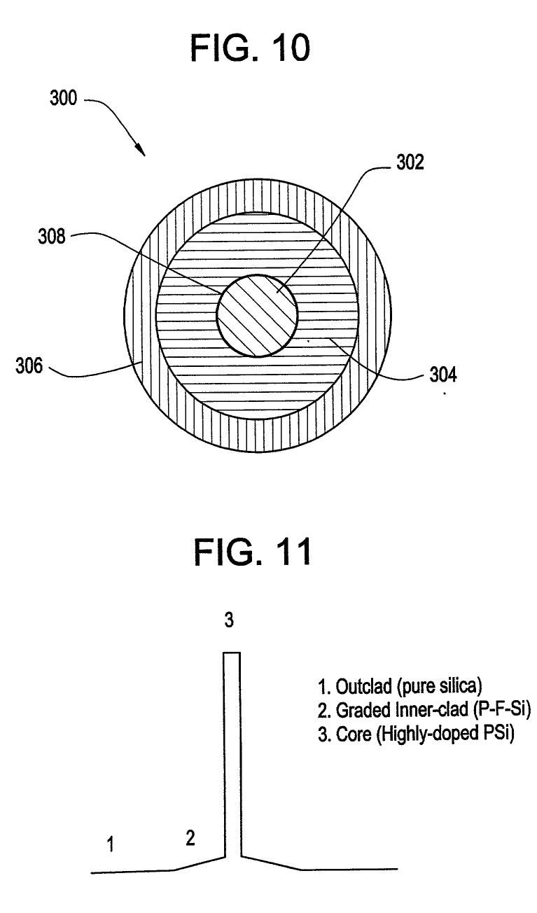

FIG. 10 illustrates an optical fiber manufactured from the cane described above including the barrier layer. Optical fiber 300 includes core 302, inner cladding 304, barrier layer 308, and outer cladding 306. Each layer composition can be manufactured in the manner described above and from the materials described above. The compositions can be transformed to corresponding layers by extrusion, drawing, or the like.

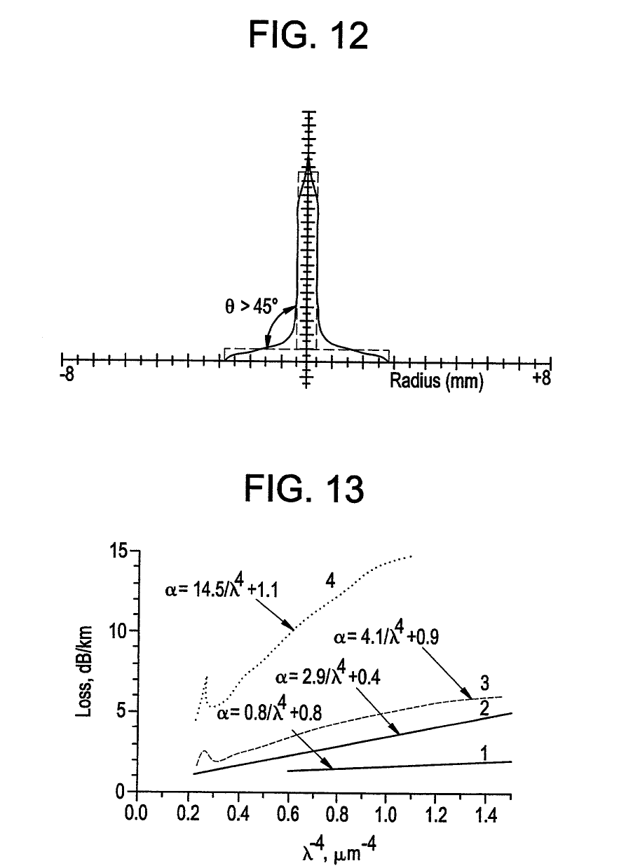

A schematic refractive index profile and an actual refractive index profile for the highly-phosphorus-doped core canes are shown in FIGS. 11 and 12, respectively. It is noted that the fiber profile of FIG. 11 minimizes the thermal and mechanical stresses and optically matches the outer clad (pure silica).

Fiber Draw Temperature

The reduced fiber draw temperatures allows to lower the fiber attenuation (i.e. optical losses) of highly P₂O₅-doped fibers substantially to a value below 2 dB/km in a wavelength range of 1000-1650 nm. The reduction in draw temperature in respect to standard silica-clad single mode fibers can be achieved by using a softer glass material for the cladding, as discussed below.

It is known that larger doping level in the fiber core typically results in the increased attenuation. FIG. 13 shows the measured loss in fibers with varying P₂O₅ core concentration between 8 mol % and 17 mol %. When the P₂O₅ content in the core is increased up to 17 mol %, both wavelength-dependent (“Raleigh”-type scattering) and wavelength-independent loss components sharply increase. There are several physical reasons for this increase. First, the microscopic variations in the doping level of the core glass formed during CVD process are not completely “washed out” by diffusion, which produces inhomogeneity of the resulting glass and related “Raleigh”-type scattering. Second, a large mismatch in the viscosity of core and cladding materials results in the appearance of imperfections and structural inhomogeneities at their boundary and therefore the increased amount of low-angle interface scattering. And third, a large mismatch in the thermal expansion coefficients between core and cladding glasses leads to varying tension in P₂O₅-doped glass and associated changes in cutoff wavelength (and hence, changes in field distribution), also resulting in the scattering loss increase. While the Raleigh scattering in the bulk of the core can be reduced by codoping the core material with F, the influence of second and third loss mechanisms can be greatly diminished by using softer cladding glass and reducing the fiber draw temperature.

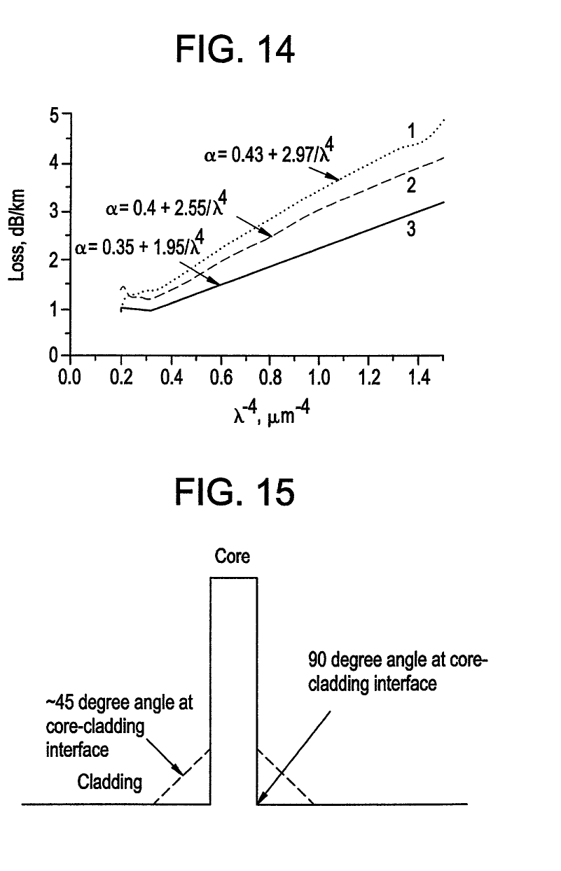

The loss reduction in P₂O₅-doped fibers drawn at lower temperature was demonstrated in the following experiment. During the drawing process the temperature was varied as a step-function from 1930° C. to 1820° C. for a phosphosilicate preform containing 13 mol % P₂O₅. Losses in each part of the fiber, drawn at constant temperature, were measured. Results for these experiments are shown in Table 1 and FIG. 14. Fiber losses decrease with temperature reduction, and this is true in the entire 800-1600 nm band.

Raman Results

To pump Raman lasers operating at 1.24 microns and 1.48 microns, Nd or Yb fiber lasers with an output wavelength of 1.06 microns are typically used. Table 2 presents optical losses in dB/km at wavelengths of 1.06, 1.24, 1.3, and 1.55 microns in single-mode, highly P₂O₅doped fibers (13 mol % P₂O₅). The reduction of optical losses in phosphosilicate core fibers has led to a considerable lowering of the intracavity losses in cascade Raman lasers, and this in turn resulted in a doubling of their efficiency.

It is noted that utilization of soft materials (i.e lower melting point than pure silica), low draw temperatures, formation of the preform with the large doped silica core (1.5 mm or larger in diameter) and, during collapsing step, keeping the burner behind the collapsing front contributed to formation of highly doped phosphosilica fiber (at least 7 mole % of P₂O₅) with reduced imperfections and reduced stress in core/cladding interface, producing extremely low attenuation loss (i.e., less than 2 dB/km, less than 1 dB/km and less than 0.2 dB/km).

The invention has been described through disclosed embodiments embodiment. However, various modifications can be made without departing from the scope of the invention as defined by the appended claims and legal equivalents.

We claim:

1. A method of making a phosphosilicate fiber, said method comprising the steps of: (i) manufacturing a preform containing phosphorus doped silica; and (ii) drawing phosphosilicate fiber from said preform at a temperature in the range of 1700° C. to 1900° C.

2. A method of making a phosphosilicate fiber according to claim 1, wherein said method further comprises the step of depositing glass material by chemical vapor deposition on a substrate; and said step of manufacturing a preform produces said preform from said glass material.

3. The method according to claim 2, wherein the step of manufacturing the fiber preform includes: (i) laying down an initial preform by vapor deposition of SiO₂ doped with P₂O₅; (ii) collapsing said initial preform, thereby forming a phosphorus doped silica core with a diameter of equal to or greater than 1.5 mm; and (iii) overcladding said initial preform with an additional amount of glass material to form a final preform.

4. The method according to claim 3, wherein said laydown step includes doping with fluorine during said deposition; and wherein after said collapsing step, said core of said collapsed initial preform contains between 0.01-1.0 atomic wt % of fluorine.

5. The method according to claim 4 wherein said core of said collapsed initial preform contains about 0.25 atomic wt % of fluorine.

6. The method according to claim 3, wherein said laydown step is achieved by laydown by MCVD inside vapor deposition and said overcladding step includes at least one sleeving step.

7. The method according to claim 1, wherein said overcladding steps includes a plurality of sleeving steps.

8. The method according to claim 3, wherein said laydown step is achieved by laydown by PCVD inside vapor deposition and said overcladding step includes at least one sleeving step.

9. The method according to claim 8, wherein said overcladding step includes a plurality of sleeving steps.

10. The method according to claim 2, wherein the fiber preform is manufactured in at least three steps, said steps being: (i) laydown of initial preform by vapor deposition of SiO₂ doped with P₂O₅; (ii) consolidating said initial preform, thereby forming a phosphorus doped core diameter of equal to or greater than 1.5 mm; and (iii) overcladding said initial preform with an additional amount of glass material to form a final preform.

11. The method according to claim 10, wherein said laydown step is achieved by laydown by OVD outside vapor deposition and said overcladding step includes at least one sleeving step.

12. The method of claim 10, wherein said overcladding step includes a plurality of sleeving steps.

13. A method of making a phosphosilicate fiber, said method comprising the steps of: (i) manufacturing a preform containing phosphorus doped silica said method further comprises the step of depositing glass material by chemical vapor deposition on a substrate; and said step of manufacturing a preform produces said preform from said glass material, wherein the step of manufacturing the fiber preform includes: (i) laying down an initial preform by vapor deposition of SiO₂ doped with P₂O₅; (ii) collapsing said initial preform, thereby forming a phosphorus doped silica core with a diameter of equal to or greater than 1.5 mm; and (iii) overcladding said initial preform with an additional amount of glass material to form a final preform, wherein the laydown of the initial preform is performed by inside vapor deposition with a burner that moves relative to said preform, said preform having a collapsing front, said burner being kept behind the collapsing front as the burner is moved along the length of said preform.

14. A method of making a phosphosilicate fiber, said method comprising the steps of: (i) manufacturing a preform containing phosphorus doped silica said method further comprises the step of depositing glass material by chemical vapor deposition on a substrate; and said step of manufacturing a preform produces said preform from said glass material, wherein the step of manufacturing the fiber preform includes: (i) laying down an initial preform by vapor deposition of SiO₂ doped with P₂O₅; (ii) collapsing said initial preform, thereby forming a phosphorus doped silica core with a diameter of equal to or greater than 1.5 mm; and (iii) overcladding said initial preform with an additional amount of glass material to form a final preform, wherein the laydown of the initial preform is performed by inside deposition and the collapsing step utilizes a burner that moves relative to said preform, said burner (i) providing a hot zone on said preform, and (ii) being positioned away from an open surface of said preform, so that said open surface is not in said hot zone.

15. The method according to claim 13, wherein said burner moves at a speed of no more than 50 mm/minute.

16. The method according to claim 13, wherein said burner moves at a speed between 10 mm/minute and 50 mm/minute.

17. The method according to claim 16, wherein said burner moves at a speed between 10 mm/minute and 40 mm/minute.

18. The method according to claim 3, where the fiber preform is made by an inside vapor deposition process, said vapor deposition being performed on inside wall of a substrate tubes made of glass with a softening and melting temperatures lower than those of pure silica glass.

19. The method according to claim 17, wherein said glass is silica glass doped with P and with a combination of dopants chosen from the group consisting of F, B, and Ge.

20. The method according to claim 17, wherein the overcladding step is performed by sleeving said collapsed preform with sleeving tubes made of glass with a softening and melting temperatures lower than that of pure silica glass.

21. The method according to claim 20, wherein said sleeving tubes are silica glass doped with P and with a combination of dopants chosen from the group consisting of F, B, and Ge.

22. The method according to claim 3, wherein the overcladding step is performed by sleeving said collapsed preform with sleeving tubes made of glass with a softening and melting temperatures lower than that of pure silica glass.

23. The method according to claim 10, wherein the overcladding step is performed by sleeving said consolidated preform with sleeving tubes made of glass with a softening and melting temperatures lower than that of pure silica glass.

24. The method according to claim 22, wherein said sleeving tubes are silica glass doped by any combination of dopants chosen from the group consisting of F, B, Ge and P.

25. The method according to claim 23, wherein said sleeving tubes are silica glass doped with a combination of dopants chosen from the group consisting of F, B, Ge and P.

26. The method according to claim 3, where the silica core of the preform is doped with 10 to 30 mole % of P₂O₅.

27. The method according to claim 10, wherein the silica core of the preform is doped with 10 to 30 mole % of P₂O₅.

28. The method according to claim 11, where the inner cladding comprises silica doped by a combination of dopants chosen from the group consisting of fluorine, boron, germania, and phosphorus.

29. The method according to claim 11, wherein water vapor is removed from said fiber preform by utilizing at least one drying agent chosen from the following: Cl₂, SiCl₄, GeCl₄, or POCl₃, said water vapors being removed at temperatures between 700° C. and 1100° C.

30. The method of claim 29, wherein said temperatures are 800 to 1000° C.

31. The method of claim 30, wherein said temperatures are 800 to 900° C.

32. The method according to claim 11, where the fiber preform is consolidated with the use of Ballast and tip plugs, at temperature of 1250 to 1450° C.

33. The method of claim 32, wherein said temperature is 1310° C.+/−25° C., for a time period long enough to sinter the cladding layer.

34. The method according to claim 11, where the fiber preform is consolidated with a downdrive speed of less than or equal to 10 mm/min, such that the centerline hole is closed, at temperatures ranging from 1250° C.-1450° C.

35. The method of claim 34, wherein said temperatures 1310° C.+/−25° C., and consolidation is performed for a time period long enough to sinter the cladding layer and close the centerline hole.

36. The method according to claim 11, where the outer cladding comprises silica doped by any combination of dopants chosen from the group consisting of fluorine, boron, germania, and phosphorus.

37. The method according to claim 11, utilizing sleeving tubes made of glass with a softening and melting temperatures lower than those of pure silica glass.

38. The method according to claim 11, said glass being silica glass doped by any combination of F, B, Ge and P.

39. The method according to claim 11, where a glassy barrier layer can be formed between the core composition and the inner cladding.

40. The method according to claim 39, where the glassy barrier is fabricated by utilizing one of the following: OVD processing, plasma torch, or a CO₂ laser.

41. The method according to claim 39, where drying of the core soot is performed prior to deposition of the glassy barrier layer.

42. The method according to claim 39, where the drying step may be performed by use of one of the following flame sources: chlorine-rich flame, dry flame source, non-OH flame sources.

43. The method of claim 42 wherein said flame is carbon monoxide or deuterium.

44. The method according to claim 39, where the glassy barrier layer is 50 microns to 100 microns thick.

45. An optical fiber comprising a silica core doped with 10 to 30 mole % of P₂O₅, said fiber having low scattering and absorption loss, so that optical signal traveling through said fiber is attenuated less than 2 dB/km in a wavelength range between 950 and 1650 nm.

46. An optical fiber according to claim 45 wherein said optical signal is attenuated less than 1 dB/km km in a wavelength range from 1000 to 1650 nm.

47. An optical fiber according to claim 45 wherein said optical signal is attenuated less than 0.2 dB/km in a wavelength range from 1000 to 1650 nm.

48. The optical fiber according to claim 45, wherein said fiber comprises an inner cladding adjacent to said silica core, wherein said inner cladding is silica doped with at least one of fluorine, boron, germania and phosphorus.

49. The optical fiber according to claim 45, said fiber further comprising an outer cladding outer cladding including silica doped with at least one of: P, F, B and Ge.

50. The method according to claim 3 wherein said overcladding step is performed by (i) chemical vapor deposition of overcladding material on the outer surface of the initial preform and (ii) sintering said overcladding material to produce said fiber preform.

51. A method of making a phosphosilicate fiber, said method comprising the steps of: (i) manufacturing a preform containing phosphorus doped silica with 0 to 6 mole % GeO₂; and (ii) drawing phosphosilicate fiber from said preform at a temperature at or below 1900° C.
